(19) United States
(12) Patent Application Publication
(10) Pub. No.: US 2022/0222164 A1
(43) Pub. Date: Jul. 14, 2022

(54) COMPUTER-READABLE RECORDING MEDIUM STORING INFORMATION COLLECTION PROGRAM, INFORMATION COLLECTION METHOD, AND INFORMATION PROCESSING APPARATUS

(71) Applicant: FUJITSU LIMITED, Kawasaki-shi (JP)

(72) Inventor: KENICHIROU SHIMOGAWA, Numazu (JP)

(73) Assignee: FUJITSU LIMITED, Kawasaki-shi (JP)

(21) Appl. No.: 17/469,934

(22) Filed: Sep. 9, 2021

(30) Foreign Application Priority Data
Jan. 8, 2021 (JP) 2021-002429

(51) Int. Cl. G06F 11/34

(52) U.S. Cl. CPC G06F 11/3419; G06F 11/3495; G06F 11/3476

(57) ABSTRACT

A non-transitory computer-readable recording medium stores an information collection program causing a computer to execute a process including: when collecting logs for a plurality of items concerning performance of a system, acquiring a current value of a load of the system and a record value of a load requested to collect the logs for the plurality of items; when a total of the current value and the record value exceeds a threshold, determining a log collection target item from the plurality of items based on access counts of logs accessed for performance monitoring among the logs collected for the plurality of items; and collecting a log for the determined log collection target item.

### CROSS-REFERENCE TO RELATED APPLICATION

This application is based upon and claims the benefit of priority of the prior Japanese Patent Application No. 2021-2429, filed on Jan. 8, 2021, the entire contents of which are incorporated herein by reference.

### FIELD

The embodiments discussed herein are related to a computer-readable recording medium storing information collection program, an information collection method, and an information processing apparatus.

### BACKGROUND

An information technology (IT) system includes, for example, hardware resources such as a host computer, a storage device, and a network device, an operating system (OS) that operates using these hardware resources, and applications that run on the OS. The IT system is enabled to satisfy user's requests only when operating normally. Therefore, it is very important to an operator to check that the IT system is operating normally by monitoring.

International Publication Pamphlet No. WO 2015/071946 and Japanese Laid-open Patent Publication Nos. 2018-160755 and 2007-26303 are disclosed as related art.

### SUMMARY

According to an aspect of the embodiments, a non-transitory computer-readable recording medium stores an information collection program causing a computer to execute a process including: when collecting logs for a plurality of items concerning performance of a system, acquiring a current value of a load of the system and a record value of a load requested to collect the logs for the plurality of items; when a total of the current value and the record value exceeds a threshold, determining a log collection target item from the plurality of items based on access counts of logs accessed for performance monitoring among the logs collected for the plurality of items; and collecting a log for the determined log collection target item.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information collection method according to an embodiment;

FIG. 2 is an explanatory diagram illustrating a system configuration example of an information processing system;

FIG. 3 is a block diagram illustrating a hardware configuration example of a task server;

FIG. 4 is an explanatory diagram illustrating an example of contents stored in a collection load table;

FIG. 5 is an explanatory diagram illustrating an example of contents stored in a reference count table;

FIG. 6 is an explanatory diagram illustrating an example of contents stored in a collection status table;

FIG. 7 is a block diagram illustrating a functional configuration example of a management server;

FIG. 8 is a block diagram illustrating a functional configuration example of the task server;

FIG. 9 is an explanatory diagram illustrating a first example of log collection by the task server;

FIG. 10 is a flowchart illustrating an example of a reference count update process procedure by the management server;

FIG. 11 is a flowchart illustrating an example of a reference count response process procedure by the management server;

FIG. 12 is a flowchart (part 1) illustrating an example of an information collection process procedure by the task server;

FIG. 13 is a flowchart (part 2) illustrating the example of the information collection process procedure by the task server;

FIG. 14 is a flowchart (part 3) illustrating the example of the information collection process procedure by the task server;

FIG. 15 is a flowchart (part 4) illustrating the example of the information collection process procedure by the task server;

FIG. 16 is a flowchart (part 5) illustrating the example of the information collection process procedure by the task server;

FIG. 17 is an explanatory diagram illustrating a second example of log collection by the task server; and

FIG. 18 is an explanatory diagram illustrating an example of determination of a resource-by-resource priority order.

### DESCRIPTION OF EMBODIMENTS

As the related art, there is a technique of calculating a value of a monitoring spike in a computer in a case where a new application and a new application probe are installed therein, and determining the computer as a candidate computer where to install the application and the application probe when the calculated value of the monitoring spike is smaller than a threshold. The value of the monitoring spike indicates a load generated by a resource monitoring probe that monitors the state of the computer and the application probe that performs monitoring in synchronization with the monitoring timing of the resource monitoring probe.

There is another technique of measuring resources consumed to collect multiple monitoring data pieces on monitoring items from a monitoring target apparatus, and selecting a monitoring interval for the monitoring target apparatus based on the redundancy among the monitoring data pieces and a load. In another technique, when there is a lack of observational information requested for performance measurement, an access generating unit is given an instruction of a predetermined access that enables the observational information to be acquired, and when the access generating unit generates the predetermined access, an observable situation suited to the lacking observational information is created and the observational information is generated.

However, in the related art, the entire system may have a high load due to a load applied for the collection of logs for performance monitoring, and therefore cause a slowdown.

For example, in the related art in which, when the value of the monitoring spike is smaller than the threshold, the computer is determined as the candidate computer for the installation location of the application and the application probe, the installation location is determined only by the load expected in advance, and it is not possible to address a case where the load varies during operation. For example, there is a case where the existing load in the installation location varies to increase and resultantly the total load of the new application and the monitoring program exceeds the threshold. There is also another case where the total load exceeds the threshold because the new application consumes resources more than expected or the monitoring program has a load equal to or more than the load expected in advance.

In one aspect, an object of the present disclosure is to reduce a slowdown of a system due to collection of logs.

Hereinafter, embodiments of an information collection program, an information collection method, and an information processing apparatus according to the present disclosure will be described in detail with reference to the drawings.

### Embodiments

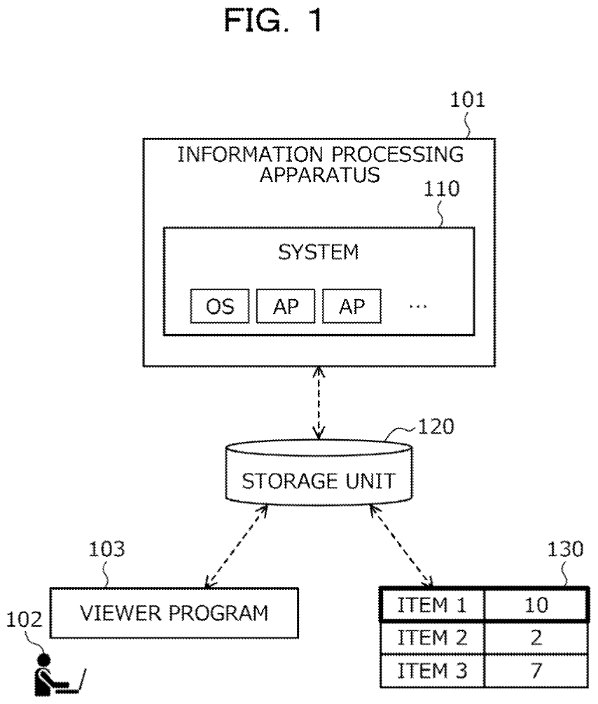

FIG. 1 is an explanatory diagram illustrating an example of an information collection method according to an embodiment. In FIG. 1, an information processing apparatus 101 is a computer that collects logs for multiple items concerning performance of a system. The system is a monitoring target system (IT system), for example, a task system. Each of the multiple items indicates, for example, a usage state of a resource by each of multiple software programs running on the system.

The software programs are an operating system (OS) and applications. The resources are hardware resources such as a central processing unit (CPU), a memory, a disk, and a communication interface (I/F). The usage state of a resource by each of the OS and the applications is one of indexes indicating the performance of the system.

Since the system is enabled to satisfy user's requests only when operating normally, it is very important to the operator to check that the system is operating normally by monitoring. An application runs using allocated hardware resources and has a tendency to increase the amount of resources used in proportion as the workload (the number of requests) increases.

On the other hand, there is an upper limit on available resources. Thus, when running short of the resources, the system may cause a slowdown and fail to satisfy the user's requests. Therefore, the operator has to run each application while checking whether the application is operating normally, but has no way to directly refer to the state of the application.

For this reason, in order to monitor whether the application is operating normally, for example, often used is a method of causing a monitoring program to monitor the state of the application and allowing the operator to refer to visualized performance information to reduce the operation load of the operator. However, use of a large amount of resources to collect logs for performance monitoring of the system may increase the load on the entire system and cause a slowdown of the system.

To address this, the present embodiment will be described regarding an information collection method which, in a case where a slowdown is expected to occur when all logs concerning the performance of the system are collected, collects only logs more important to the operator instead of collecting all the logs and thereby reduces the occurrence of a slowdown due to the collection of the logs.

(1) When collecting logs for multiple items concerning the performance of the system, the information processing apparatus 101 acquires a current value of a load of the system and a record value of a load that was requested to collect the logs for the multiple items. The current value is the current load of the entire system. The record value represents the total of the loads that were requested to collect the logs for the respective items in the past.

For example, the information processing apparatus 101 acquires the record value of the load requested to collect the log for each of the multiple items. The information processing apparatus 101 acquires, as the record value of the load requested to collect the logs for the multiple items, a value (total value) obtained by adding up the acquired record values of the loads requested to collect the logs for the multiple items. The information processing apparatus 101 acquires the current value of the load of the system from the OS of the system.

In the example illustrated in FIG. 1, the monitoring target system is a “system 110” and the multiple items concerning the performance of the system 110 are “items 1 to 3”. In this case, the current value of the load of the system 110 and the record value of the load requested to collect the logs for the items 1 to 3 are acquired. The system 110 is implemented by, for example, the information processing apparatus 101. Instead, the system 110 may be implemented by another computer different from the information processing apparatus 101 or by a plurality of computers including the information processing apparatus 101.

(2) When the total of the acquired current value and the acquired record value exceeds a threshold, the information processing apparatus 101 determines a log collection target item from the multiple items based on access counts of the logs accessed for the performance monitoring among the logs collected for the multiple items. The threshold may be set to any value. For example, the threshold is set to such a value that the system (service) is expected to cause a slowdown when the total of the current value and the record value exceeds the threshold.

In the performance monitoring of the system 110, an operator 102 refers to, for example, the visualized performance information and monitors whether each application (“AP” in FIG. 1) running on the system 110 is operating normally. The performance information is information indicating the performance of the system and is generated based on the logs concerning the performance of the system.

For example, the performance information is information such as graphs or a table generated based on the logs indicating the usage states of the resources (such as the CPU, the memory, and the disk) by the OS and the applications. In more detail, for example, the performance information is a line graph indicating a temporal change in the usage rate of the CPU by a certain application within a specified period.

The performance information that is referred to a larger number of times in the performance monitoring is considered to be information to which the operator 102 pays more attention and therefore be information more important to the operator 102. For example, a viewer program 103 generates the performance information by accessing a storage unit 120 that accumulates the collected logs, and presents the performance information to the operator 102. Therefore, a log having a larger access count (number of accesses) among the logs stored in the storage unit 120 is considered to be information more important to the operator.

For this reason, for example, when the total of the current value and the record value exceeds the threshold, the information processing apparatus 101 determines log collection target items in descending order of the access count of the log from among the multiple items. For example, in a situation where the system is expected to cause a slowdown if all the logs are collected, the information processing apparatus 101 collects not all the logs but some of the logs that are considered to be important to the operator.

The example illustrated in FIG. 1 assumes that the total of the current value of the load of the system 110 and the record value of the load requested to collect the logs for the items 1 to 3 exceeds a threshold. In this case, the information processing apparatus 101 determines a log collection target item from among the items 1 to 3 based on the access counts of the logs accessed for performance monitoring among the logs for the items 1 to 3 stored in the storage unit 120.

For example, the access counts of the logs stored in the storage unit 120 are “10” for the item 1, “2” for the item 2, and “7” for the item 3 (see an access table 130 in FIG. 1). In this case, for example, the information processing apparatus 101 refers to the access table 130 and preferentially determines, as a log collection target item, the item 1 having the largest access count of the log among the items 1 to 3.

The storage unit 120 may be included in the information processing apparatus 101 or may be included in a computer different from the information processing apparatus 101. The different computer may be, for example, a server that manages logs or a personal computer (PC) used by the operator 102.

(3) The information processing apparatus 101 collects the log for the determined log collection target item. In the example illustrated in FIG. 1, the log is collected for the item 1 determined as the log collection target item among the items 1 to 3.

As described above, the information processing apparatus 101 is able to collect logs important to the operator while reducing the occurrence of a slowdown due to the collection of the logs for performance monitoring of the system. In the example illustrated in FIG. 1, it is possible to collect the log for the item 1 considered to be important to the operator while reducing the occurrence of a slowdown due to the consumption of many resources for collecting logs for the performance monitoring of the system 110. Thus, for example, it is possible to avoid a slowdown of a service provided by the system 110, and to reduce the occurrence of a situation where the desired performance information is not referable by the operator, thereby causing no hindrance to performance trouble investigation.

### System Configuration Example of Information Processing System 200

Next, description will be given for a system configuration example of an information processing system 200 including the information processing apparatus 101 illustrated in FIG. 1. A case where the information processing apparatus 101 illustrated in FIG. 1 is applied to a task server 201 in the information processing system 200 will be described herein as an example. The information processing system 200 is applied to, for example, a computer system that performs performance monitoring of an IT system.

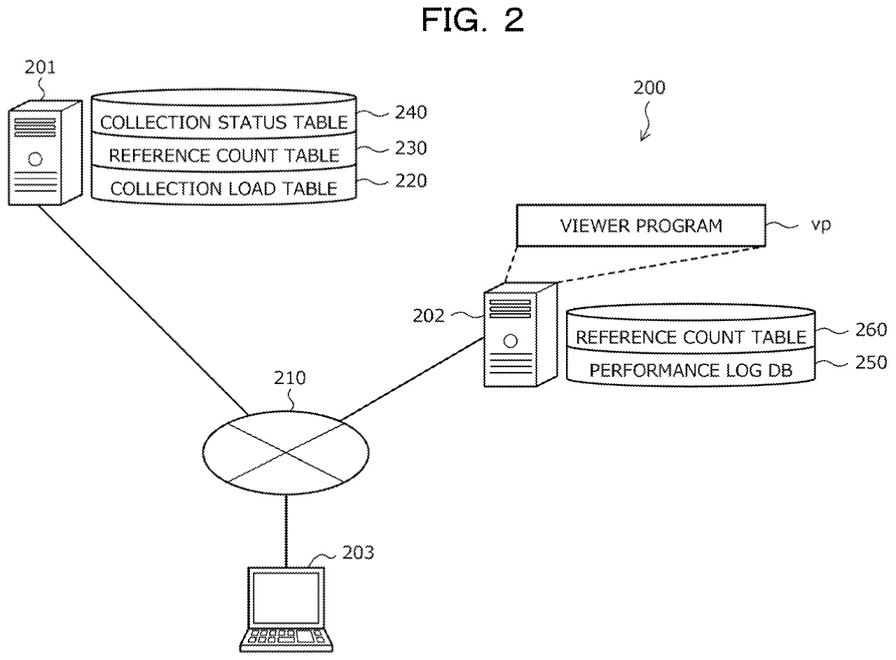

FIG. 2 is an explanatory diagram illustrating a system configuration example of the information processing system 200. In FIG. 2, the information processing system 200 includes the task server 201, a management server 202, and an operator terminal 203. In the information processing system 200, the task server 201, the management server 202, and the operator terminal 203 are coupled to one another via a wired or wireless network 210. The network 210 is, for example, the Internet, a local area network (LAN), a wide area network (WAN), or the like.

The task server 201 is a computer that includes a collection load table 220, a reference count table 230, and a collection status table 240, and that collects logs for multiple items indicating performance of a monitoring target system. The task server 201 is capable of running, for example, a virtual machine (VM).

The virtual machine is a virtual computer that runs in an execution environment constructed by dividing hardware resources of a physical computer.

The virtual machine is implemented by virtualizing hardware resources with, for example, a hypervisor. The task server 201 is capable of operating an OS by using the virtual machine and thereby running various applications.

A system S# is an example of a monitoring target system. The system S# includes an OS that operates by using the hardware resources of the task server 201 and applications (for example, AP1, AP2, and AP3) that run on the OS. The system S# may be implemented by, for example, a VM or a real machine (task server 201).

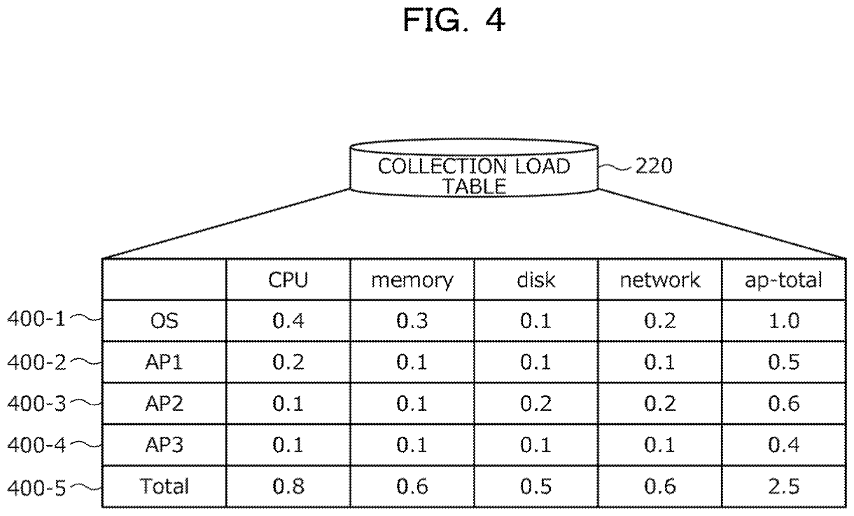

Contents stored in the collection load table 220, the reference count table 230, and the collection status table 240 will be described later with reference to FIGS. 4 to 6.

The management server 202 is a computer that includes a performance log DB 250 and a reference count table (copy source) 260 and that accumulates logs collected by the task server 201. The performance log DB 250 records the logs collected by the task server 201. The logs to be collected are logs for multiple items indicating the performance of the monitoring target system.

The reference count table (copy source) 260 is a storage unit that is a copy source of information to be stored in the reference count table 230 of the task server 201. The management server 202 includes a viewer program vp. The viewer program vp is software for displaying and browsing the performance information of the monitoring target system.

The operator terminal 203 is a computer used by an operator who operates the monitoring target system. For example, the operator is allowed to refer to the performance information by activating the viewer program vp on the management server 202 from the operator terminal 203. The operator terminal 203 is, for example, a PC, a tablet PC, or the like.

The information processing system 200 may include, for example, multiple management servers 202 and multiple operator terminals 203. The task server 201 may be implemented by, for example, multiple computers.

### Hardware Configuration Example of Task Server 201

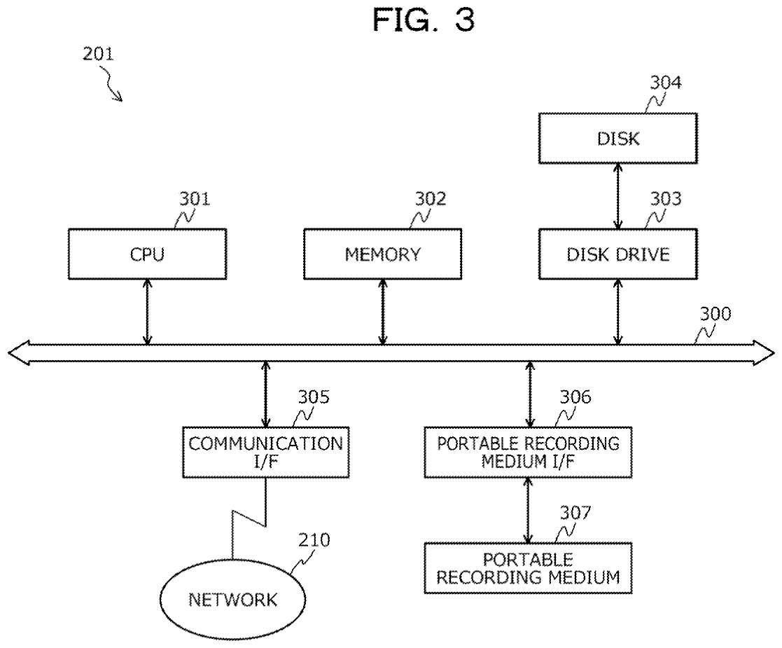

FIG. 3 is a block diagram illustrating a hardware configuration example of the task server 201. In FIG. 3, the task server 201 includes a CPU 301, a memory 302, a disk drive 303, a disk 304, a communication I/F 305, a portable recording medium I/F 306, and a portable recording medium 307. These components are coupled to one another through a bus 300.

The CPU 301 controls the entire task server 201. The CPU 301 may include multiple cores. The memory 302 includes, for example, a read-only memory (ROM), a random-access memory (RAM), a flash ROM, and the like. For example, the flash ROM stores a program of the OS, the ROM stores application programs, and the RAM is used as a work area for the CPU 301. The programs stored in the memory 302 are loaded by the CPU 301, thereby causing the CPU 301 to execute coded processing.

The disk drive 303 controls reading and writing of data from and to the disk 304 in accordance with the control of the CPU 301. The disk 304 stores the data written under the control of the disk drive 303. Examples of the disk 304 include a magnetic disk, an optical disk, and the like.

The communication I/F 305 is coupled to the network 210 via a communication line and is coupled to an external computer (for example, the management server 202 illustrated in FIG. 2) via the network 210. The communication I/F 305 functions as an interface between the network 210 and the inside of the task server, and controls input and output of data from and to the external computer. As the communication I/F 305, for example, a modem, a LAN adapter, or the like may be used.

The portable recording medium I/F 306 controls reading and writing of data from and to the portable recording medium 307 in accordance with the control of the CPU 301. The portable recording medium 307 stores the data written under the control of the portable recording medium I/F 306. Examples of the portable recording medium 307 include a compact disk (CD)-ROM, a Digital Versatile Disk (DVD), a Universal Serial Bus (USB) memory, and the like.

The task server 201 may include, for example, an input device, a display, and so on in addition to the components described above. The management server 202 and the operator terminal 203 illustrated in FIG. 2 may each also be implemented by the same hardware configuration as that of the task server 201. However, the operator terminal 203 includes, for example, an input device, a display, and so on in addition to the components described above.

### Contents Stored in Tables 220, 230, and 240

Next, the contents stored in the tables 220, 230, and 240 will be described with reference to FIGS. 4 to 6. The tables 220, 230, and 240 are each implemented, for example, by the storage device such as the memory 302 or the disk 304 illustrated in FIG. 3.

FIG. 4 is an explanatory diagram illustrating an example of contents stored in the collection load table 220. In FIG. 4, the collection load table 220 stores collection load information 400-1 to 400-5 concerning software programs (OS, AP1, AP2, and AP3) running on the system S# (monitoring target system).

The collection load information 400-1 indicates record values of loads requested to collect logs for the OS running on the system S#. The unit of the record value is [%]. The logs for the OS indicate the usage states of the respective resources (CPU, memory, disk, and network) by the OS, where CPU represents, for example, the CPU 301 illustrated in FIG. 3, memory represents, for example, the memory 302 illustrated in FIG. 3, disk represents, for example, the disk 304 illustrated in FIG. 3, and network represents, for example, the communication I/F 305 illustrated in FIG. 3.

In the collection load information 400-1, “OA” associated with OS/CPU indicates the record value of the load requested to collect the log indicating the usage state of the CPU by the OS, “0.3” associated with OS/memory indicates the record value of the load requested to collect the log indicating the usage state of the memory by the OS, “0.1” associated with OS/disk indicates the record value of the load requested to collect the log indicating the usage state of the disk by the OS, “0.2” associated with OS/network indicates the record value of the load requested to collect the log indicating the usage state of the network by the OS, and “1.0” associated with OS/ap-total indicates a value obtained by adding up the record values of the loads requested to collect the logs indicating the usage states of the respective resources by the OS.

The collection load information 400-2 indicates record values of loads requested to collect logs for the AP1 running on the system S#. The collection load information 400-3 indicates record values of loads requested to collect logs for the AP2 running on the system S#. The collection load information 400-4 indicates record values of loads requested to collect logs for the AP3 running on the system S#.

The logs for each of the AP1 to AP3 indicate the usage states of the respective resources (CPU, memory, disk, and network) by the AP1, AP2, or AP3. For example, in the collection load information 400-2, “0.2” associated with AP1/CPU indicates the record value of the load requested to collect the log indicating the usage state of the CPU by the AP1, “0.1” associated with AP1/memory indicates the record value of the load requested to collect the log indicating the usage state of the memory by the AP1, “0.1” associated with AP1/disk indicates the record value of the load requested to collect the log indicating the usage state of the disk by the AP1, “0.1” associated with AP1/network indicates the record value of the load requested to collect the log indicating the usage state of the network by the AP1, and “0.5” associated with AP1/ap-total indicates a value obtained by adding up the record values of the loads requested to collect the logs indicating the usage states of the respective resources by the AP1.

The collection load information 400-5 indicates a record value of a total load requested to collect the logs for all the software programs (OS, AP1, AP2, and AP3) running on the system S#. In the collection load information 400-5, “0.8” associated with Total/CPU indicates the record value of the load requested to collect the logs indicating the usage state of the CPU by all the software programs, “0.6” associated with Total/memory indicates the record value of the load requested to collect the logs indicating the usage state of the memory by all the software programs, “0.5” associated with Total/disk indicates the record value of the load requested to collect the logs indicating the usage state of the disk by all the software programs, “0.6” associated with Total/network indicates the record value of the load requested to collect the logs indicating the usage state of the network by all the software programs, and “2.5” associated with Total/ap-total indicates a value obtained by adding up the record values of the loads requested to collect the logs indicating the usage states of the respective resources by all the software resources.

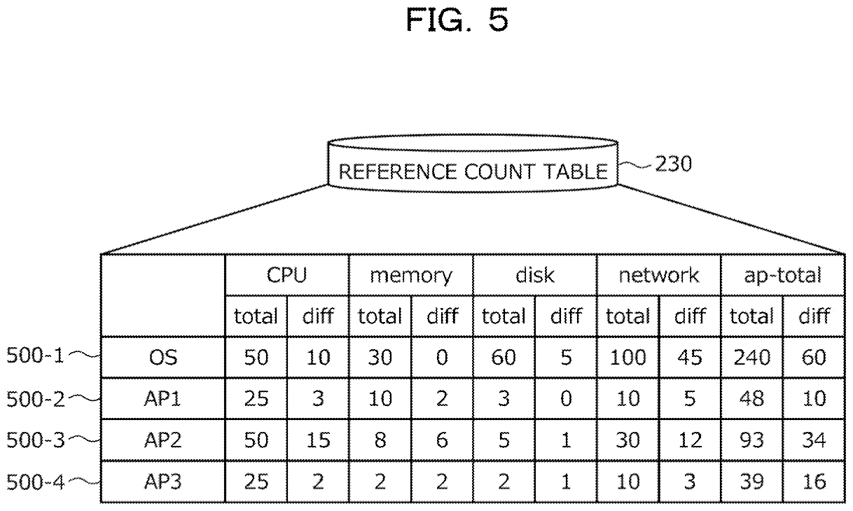

FIG. 5 is an explanatory diagram illustrating an example of contents stored in the reference count table 230. In FIG. 5, the reference count table 230 stores reference count information 500-1 to 500-4 concerning the logs for the software programs running on the system S# (monitoring target system).

The reference count information 500-1 indicates the access counts of the logs for the OS running on the system S#. The unit of the access count is [the number of accesses]. For example, the reference count information 500-1 indicates the access counts of the logs indicating the usage states of the respective resources (CPU, memory, disk, and network) by the OS among the collected logs stored in the performance log DB 250 (see FIG. 2). Then, ap-total indicates the total of the access counts of the logs indicating the usage states of the respective resources by the OS.

The access counts include total and diff. Here, total indicates an access count (number of accesses) from the start of the performance monitoring of the system S# to a current (latest) collection timing. The collection timing is a timing for collecting the logs for the software programs running on the system S#. Then, diff indicates an access count (number of accesses) from the previous collection timing to the current (latest) collection timing.

The reference count information 500-2 to 500-4 indicates the access counts of the logs for the respective applications AP1 to AP3 running on the system S#. For example, the reference count information 500-2, 500-3, or 500-4 indicates the access counts of the logs indicating the usage states of the respective resources (CPU, memory, disk, and network) by each of the AP1 to AP3 among the collected logs stored in the performance log DB 250. Then, ap-total indicates the total access counts of the logs indicating the usage states of the respective resources by each of the applications AP1 to AP3.

Since contents stored in the reference count table (copy source) 260 included in the management server 202 are the same as those of the reference count table 230, illustration and description thereof will be omitted herein.

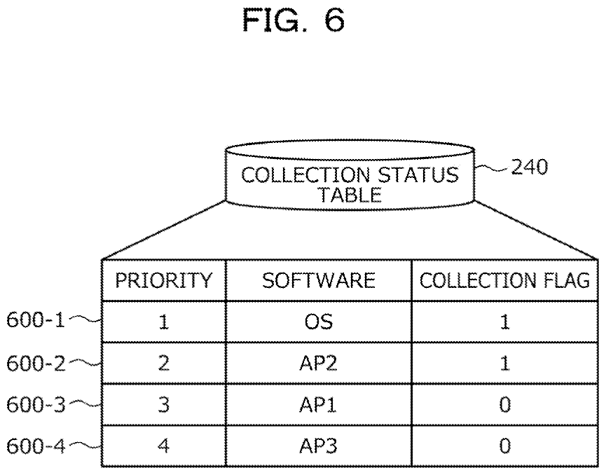

FIG. 6 is an explanatory diagram illustrating an example of contents stored in the collection status table 240. In FIG. 6, the collection status table 240 has fields of priority, software, and collection flag, and stores collection status information 600-1 to 600-4 as records by setting information in all the fields.

The priority indicates a priority for log collection. The smaller the value, the higher the priority. The software indicates a software program as a log collection target. The collection flag indicates whether a log has been collected. The collection flag “0” indicates that a log has not been collected. The collection flag “1” indicates that a log has been collected.

In the example of FIG. 6, the collection status information is stored for each of the software programs as log collection targets. However, the collection status information is not limited thereto. For example, the collection status table 240 may store the collection status information for each resource used by each of the software programs as the log collection targets.

### Functional Configuration Example of Management Server 202

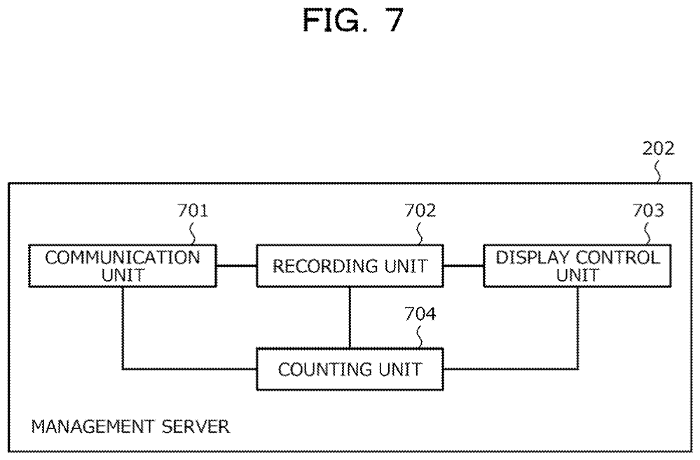

FIG. 7 is a block diagram illustrating a functional configuration example of the management server 202. In FIG. 7, the management server 202 includes a communication unit 701, a recording unit 702, a display control unit 703, and a counting unit 704. The communication unit 701 to the counting unit 704 are functions constituting a control unit and these functions are each implemented, for example, by using the communication I/F or by causing the CPU to execute a program stored in the storage device such as the memory, the disk, or the portable recording medium of the management server 202 (for example, see FIG. 3). The processing results obtained by each of the functional units are stored, for example, in the storage device such as the memory or the disk.

The communication unit 701 receives logs concerning the performance of the monitoring target system. The log concerning the performance of the system is a log for at least one of multiple items concerning the performance of the system. Each item indicates, for example, a usage state of a resource (CPU, memory, disk, or network) by a software program (each of OS and applications) running on the system.

Each log is, for example, information indicating a collection time and a usage state of a resource by a software program in association with each other. The collection time indicates date and time when the log was collected. The usage state of the resource is, for example, a usage rate (%) of the CPU or the like. For example, the communication unit 701 receives logs concerning the performance of the system S# from the task server 201.

The recording unit 702 records the received logs. For example, the recording unit 702 writes the logs received from the task server 201 to the performance log DB 250 illustrated in FIG. 2.

The display control unit 703 displays the performance information of the monitoring target system based on the recorded logs. The performance information is information indicating the performance of the system and is, for example, a graph, a table, or the like generated based on the logs indicating the usage states of the resources by the OS and the applications.

For example, the display control unit 703 receives a designation of performance information to be displayed from the operator terminal 203 by way of the viewer program vp (see FIG. 2). The display control unit 703 reads the logs for displaying the designated performance information from the performance log DB 250. Next, the display control unit 703 generates the designated performance information based on the read logs.

As an example, the performance information to be displayed is assumed to be performance information indicating a temporal change in the usage rate of the CPU by the AP1 (application) within a specified period. In this case, the display control unit 703 reads the logs indicating the usage rate of the CPU by the AP1 within the specified period from the performance log DB 250. Based on the read logs, the display control unit 703 generates the performance information indicating the temporal change in the usage rate of the CPU by the AP1 within the specified period.

The display control unit 703 displays the generated performance information on the operator terminal 203 by way of the viewer program vp. On the operator terminal 203, the operator is capable of monitoring whether the AP1 (application) is operating normally by referring to the performance information indicating the temporal change in the usage rate of the CPU by the AP1 within the specified period, for example.

The counting unit 704 makes the access counts of the logs accessed for performance monitoring among the collected logs (the logs for multiple items concerning the performance of the system). For example, every time the logs for displaying the designated performance information are read from the performance log DB 250, the counting unit 704 increments the access counts of the logs.

In more detail, for example, the counting unit 704 increments the access counts (total and diff) of the concerned logs in the reference count table (copy source) 260. For example, in order to display the performance information indicating the temporal change in the usage rate of the CPU by the AP1, the logs indicating the usage rate of the CPU by the AP1 within the specified period are read from the performance log DB 250. In this case, the counting unit 704 updates (increments) both of the access counts (total and diff) of the logs indicating the usage state of the CPU in the reference count information 500-2 of the reference count table (copy source) 260.

In order to display the performance information indicating a temporal change in the usage rate of the network by the AP2, logs indicating the usage rate of the network by the AP2 within the specified period are read from the performance log DB 250. In this case, the counting unit 704 updates (increments) both of the access counts (total and cliff) of the logs indicating the usage state of the network in the reference count information 500-3 of the reference count table (copy source) 260.

The communication unit 701 transmits the reference count information in response to a request to acquire the reference count information. The reference count information is information indicating the access counts of the collected logs. For example, when receiving a request to acquire the reference count information from the task server 201, the communication unit 701 transmits all the reference count information in the reference count table (copy source) 260 to the task server 201.

In response to the transmission of all the reference count information in the reference count table (copy source) 260, the communication unit 701 clears all the access counts (diff) in the reference count information in the reference count table (copy source) 260. Thus, the access counts (diff) from the previous collection timing are reset (to 0).

### Functional Configuration Example of Task Server 201

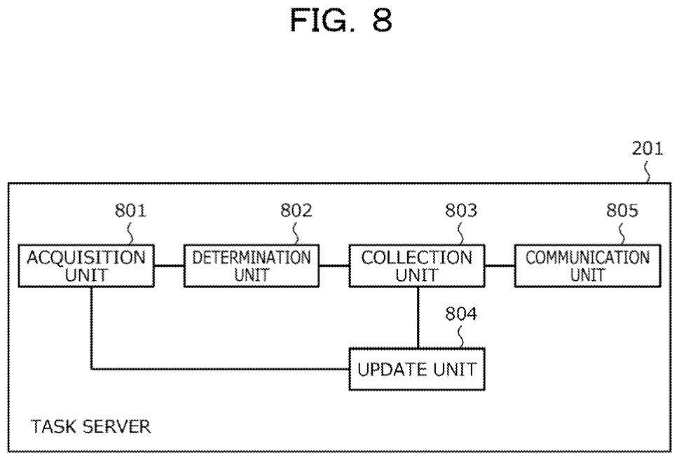

FIG. 8 is a block diagram illustrating a functional configuration example of the task server 201. In FIG. 8, the task server 201 includes an acquisition unit 801, a determination unit 802, a collection unit 803, an update unit 804, and a communication unit 805. The acquisition unit 801 to the communication unit 805 are functions constituting a control unit, and these functions are each implemented, for example, by using the communication I/F 305 or by causing the CPU 301 to execute a program stored in the storage device such as the memory 302, the disk 304, or the portable recording medium 307 illustrated in FIG. 3. The processing results obtained by each of the functional units are stored, for example, in the storage device such as the memory 302 or the disk 304.

When collecting the logs for the multiple items concerning the performance of the monitoring target system, the acquisition unit 801 acquires the current value of the load of the system and the record value of the load that was requested to collect the logs for the multiple items. The logs are collected at predetermined time intervals, for example. The predetermined time interval may be set to any time interval, and is set to, for example, a time period of approximately several tens of seconds to several minutes.

In the following description, the predetermined time interval set in advance may be referred to as a “log collection period”. The current value of the load of the system may be referred to as a “system load Lc”, and the record value of the load that was requested to collect the logs for the multiple items may be referred to as a “total collection load La”.

For example, the acquisition unit 801 acquires the system load Lc of the system S# from the OS of the system S# for each log collection period. The total collection load La is obtained by adding up the record values of the loads that were requested to lastly collect all the logs for the multiple items. For example, for each log collection period, the acquisition unit 801 refers to the collection load table 220 illustrated in FIG. 4 and acquires “2.5” associated with Total/ap-total as the total collection load La.

Total/ap-total represents the total collection load La of the loads that were requested to collect the logs for the multiple items concerning the performance of the system S#. In more detail, for example, Total/ap-total is a value obtained by adding up the record values of the loads requested to collect the logs indicating the usage states of the respective resources by all the software programs (OS and AP1 to AP3), and therefore represents the total collection load La.

The acquisition unit 801 acquires the reference count information indicating the access counts of the logs accessed for performance monitoring among the logs collected for the multiple items. For example, for each log collection period, the acquisition unit 801 transmits a request to acquire the reference count information to the management server 202 and receives the reference count information from the management server 202.

The received reference count information is, for example, the reference count information indicating the access counts of the logs indicating the usage states of the resources by the software programs (OS and AP1 to AP3), and is all the reference count information in the reference count table (copy source) 260 included in the management server 202. The received reference count information is stored (overwritten and saved) in, for example, the reference count table 230 illustrated in FIG. 5.

The determination unit 802 determines a log collection target item among the multiple items. For example, the determination unit 802 determines whether the total of the system load Lc and the total collection load La exceeds a threshold Th. The threshold Th may be set to any value. For example, the threshold Th is set to such a value (such as 85 [%]) that the system S# is expected to cause a slowdown when the total of the system load Lc and the total collection load La exceeds the threshold.

When the total of the system load Lc and the total collection load La is equal to or smaller than the threshold Th, the determination unit 802 determines all of the multiple items as log collection target items. For example, when the system S# is expected to cause no slowdown even if the logs for all S the multiple items are collected, all the logs concerning the performance of the system S# are determined as collection targets.

On the other hand, when the total of the system load Lc and the total collection load La exceeds the threshold Th, the determination unit 802 determines a log collection target item among the multiple items based on the acquired reference count information. In more detail, for example, with reference to the reference count table 230, the determination unit 802 determines a log collection target item among the multiple items in descending order of the access count of the log.

At this time, the determination unit 802 may determine a software-by-software priority order based on ap-total of the software programs (for example, OS, AP1, AP2, and AP3) in the reference count table 230. Here, ap-total indicates the total of the access counts of the logs indicating the usage states of the respective resources by each software program.

The determined software-by-software priority order (priority) is stored, for example, in the collection status table 240 illustrated in FIG. 6.

As an example, the threshold Th is assumed to be “Th=80 [%]”. The record values of the loads requested to collect the logs for the software programs (OS, AP1, AP2, and AP3) are assumed to be the values in the collection load table 220 illustrated in FIG. 4. The total collection load La is “2.5” associated with Total/ap-total in the collection load table 220. The logs for the OS are assumed to be collected with the highest priority. In this case, the priority order determined based on ap-total of the software programs (AP1, AP2, and AP3) in the reference count table 230 is “OS→AP2→AP1→AP3”.

Thus, for example, when the system load Lc is equal to or lower than 77.5 [%], the determination unit 802 determines the logs for all the software programs (OS, AP2, AP1, and AP3) as collection targets. For example, the determination unit 802 determines the items indicating the usage states of the respective resources by all the software programs (OS, AP2, AP1, and AP3) as the log collection target items.

When the system load Lc is 77.5 [%] to 77.9 [%], both inclusive, the margin is 2.1 [%]. In this case, the determination unit 802 determines, as collection targets, the logs for the software programs (OS, AP2, and AP1) in descending order of priority (first to third highest priorities). For example, the determination unit 802 determines the items indicating the usage states of the respective resources by the three software programs (OS, AP2, and AP1) as the log collection target items.

When the system load Lc is 78.0 [%] to 78.4 [%], both inclusive, the margin is 1.6 [%]. In this case, the determination unit 802 determines, as collection targets, the logs for the software programs (OS and AP2) in descending order of priority. For example, the determination unit 802 determines the items indicating the usage states of the respective resources by the two software programs (OS and AP2) as the log collection target items.

When the system load Lc is 78.5 or above, the margin is 1.5 [%]. In this case, the AP (AP with the highest priority) for which the logs are collectable together with the logs for the OS is not found. For this reason, the determination unit 802 determines no logs as the collection targets. For example, the determination unit 802 does not determine any log collection target item. However, since the margin is 1.5 [%], the determination unit 802 may determine the logs for the OS (1.0 [%]) and the AP3 (0.4 [%]) as the collection targets without considering the priority order of the APs.

The determination unit 802 may determine a priority order on a resource-by-resource basis for the software programs based on the access counts of the logs indicating the usage states of the respective resources by each of the software program. The access counts of the logs indicating the usage states of the respective resources by each of the software programs are, for example, the access count of the logs indicating the usage state of the CPU by the AP1, the access count of the logs indicating the usage state of the memory by the AP1, and the like.

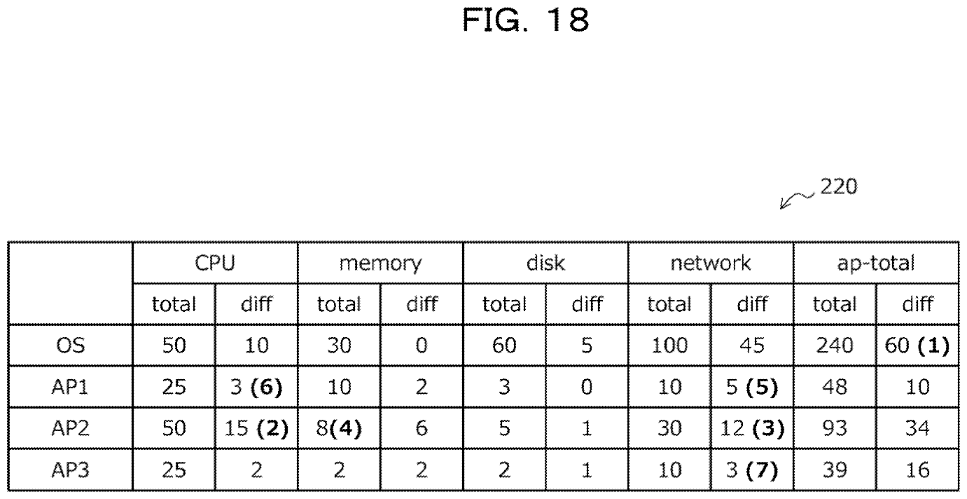

An example of determining the resource-by-resource priority order for the software programs will be described later with reference to FIG. 18.

Examples of the access counts include total and diff. For example, total is the access count of the logs accessed for performance monitoring in a period from the start of the performance monitoring of the system S# to the current collection timing. Then, diff is the access count of the logs accessed for the performance monitoring in a period from the previous collection timing to the current collection timing.

The determination unit 802 may use the access count of at least one of total and diff, or may use the access counts of both of total and diff. For example, when the latest access count is considered to be important (the larger the latest reference count of the performance information, the more important to the operator), the determination unit 802 may use diff as the access count. When the total access count is considered to be important (the larger the long-term reference count of the performance information, the more important to the operator), the determination unit 802 may use total as the access count.

In more detail, for example, the determination unit 802 may determine the priority order on a software-by-software basis (or resource-by-resource basis) by using diff as the access counts, and may determine the priority order for software programs having the same access count in diff by using total as the access counts. The determination unit 802 may randomly determine the priority order for software programs having the same access counts in total and diff.

The determination unit 802 may determine a log collection target item based on the types of the software programs. For example, the determination unit 802 may determine, as the log collection target items, the items indicating the usage states of the resources by the OS preferentially over the items indicating the usage states of the resources by the applications (AP1, AP2, and AP3).

In a conceivable application example of the performance information, the operator first checks the performance information on the OS, and, when finding that the load is abnormally high, investigates a cause for the performance trouble by checking the performance information on the APs, for example. Therefore, the logs for the OS may be collected with the highest priority in order to check the performance value of the entire system. However, it is difficult to investigate the cause only with the logs for the OS. For this reason, in a situation where it is possible to collect only the logs for the OS, all the logs including the logs for the OS may not be collected.

The collection unit 803 collects the logs for the determined log collection target items. For example, the log collection target items herein are assumed to be items indicating the usage states of the respective resources (CPU, memory, disk, and network) by the AP1. In this case, the collection unit 803 collects the logs indicating the usage states of the respective resources by the AP1.

When the logs indicating the usage states of the respective resources by the AP1 are collected, the collection flag of the collection status information 600-3 in the collection status table 240 illustrated in FIG. 6 is changed from “0” to “1”, for example. This makes it possible to identify items for which the logs have been collected (for example, the items indicating the usage states of the respective resources by the AP1) among the multiple items.

The collection unit 803 measures loads requested to collect the logs for each of the log collection target items. For example, for a process of collecting the logs for each of the log collection target items, the collection unit 803 acquires, from the OS, the load at the start of the log collection and the load at the end of the log collection. The collection unit 803 measures the load requested to collect the logs based on the difference between the acquired loads.

The update unit 804 updates the loads requested to collect the logs for the log collection target items. For example, the update unit 804 records, in the collection load table 220, the measured loads requested to collect the logs for the log collection target items.

For example, it is assumed that the loads requested to collect the logs indicating the usage states of the respective resources (CPU, memory, disk, and network) by the AP1 are measured. In this case, the update unit 804 updates the load for each of the resources (CPU, memory, disk, or network) in the collection load information 400-2 in the collection load table 220 to the measured load.

Thus, it is possible to estimate the total collection load La by using the latest loads requested to collect the logs for the application (for example, the AP1), which are the loads measured under the condition where the running state of the application may be close to the current running state. For this reason, even in the case where the loads requested to collect the logs vary due to a change in the running state of the application, the accuracy of estimating the total collection load La may be improved.

The collection unit 803 collects the logs for the remaining items other than the log collection target items among the multiple items at a predetermined time point in the period from the current collection timing to the next collection timing. The predetermined time point may be set to any time point. For example, the predetermined time point may be set to a middle time point by which the period from the current collection timing to the next collection timing is divided into two.

For example, the acquisition unit 801 acquires the system load Lc of the system S# at the predetermined time point in the period from the current collection timing to the next collection timing. Next, the determination unit 802 determines a log collection target item from among the remaining items, depending on the difference between the threshold Th and the system load Lc acquired at the predetermined time point, based on the access counts of the logs accessed for performance monitoring among the logs collected for the remaining items.

In more detail, for example, the determination unit 802 determines the log collection target item from among the remaining items in descending order of the access count of the logs. The remaining items may be identified from the collection status table 240, for example. For example, the determination unit 802 refers to the collection status table 240 and determines, as a log collection target item, the software program having the highest priority among the software programs each having the collection flag of “0”. The collection unit 803 collects the logs for the determined log collection target item.

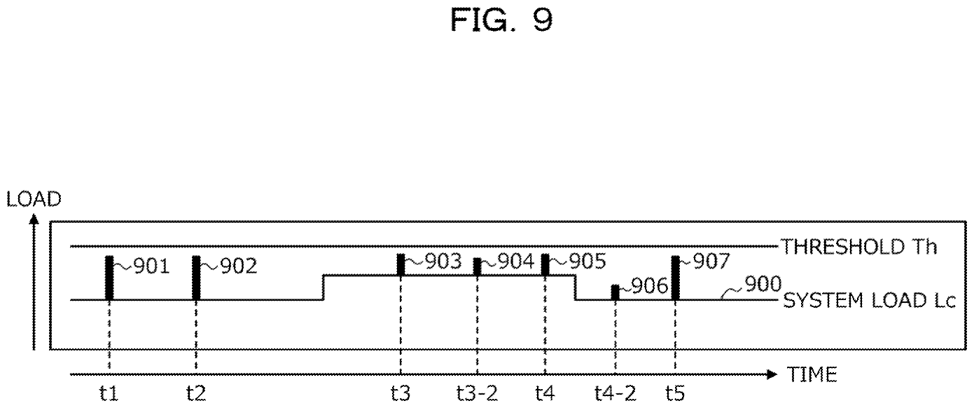

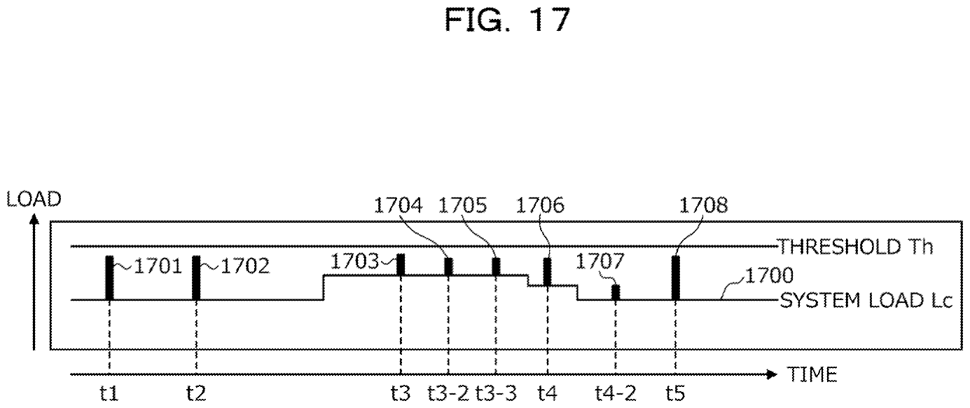

An example of log collection will be described later with reference to FIGS. 9 and 17.

The collection unit 803 may determine the predetermined time point for collecting the logs for the remaining items, based on the number of log collection target items and the number of remaining items which are determined at the current collection timing. The predetermined time point is one or more time points in the period from the current collection timing to the next collection timing.

For example, it is assumed that there are six software programs (collection targets) of OS/AP1/AP2/AP3/AP4/AP5 and logs for only the two software programs of OS and AP1 are collected at the first timing (current collection timing). In this case, the possibility of the successful collection for the remaining four software programs is higher if the collection is performed by being divided into two. For this reason, for example, the collection unit 803 divides the period from the current collection timing to the next collection timing into three, and sets the two dividing points as predetermined time points (collection points).

This makes the number of divisions variable to appropriately distribute the load requested to collect the logs for the multiple items, which makes it possible to collect the logs for all the multiple items while keeping the load within a range not exceeding the threshold Th, for example, without causing a slowdown.

An item having the access count equal to or less than a predetermined number among the remaining items may be excluded from the log collection target items. The predetermined number may be set to any value.

For example, the predetermined number may be a predetermined fixed value or may be a variable value determined based on the largest access count among those of the multiple items (for example, a value of 10% of the largest access count).

The communication unit 805 transmits the collected logs. For example, every time the logs are collected, the communication unit 805 may transmit the collected logs to the management server 202. Instead, the communication unit 805 may collectively transmit all the collected logs (logs collected at the current collection timing) to the management server 202 at any timing before the next collection timing.

### First Example of Log Collection by Task Server 201

Next, a first example of log collection by the task server 201 will be described with reference to FIG. 9.

FIG. 9 is an explanatory diagram illustrating a first example of log collection by the task server 201. In FIG. 9, a graph 900 illustrates a temporal change in the system load Lc of the system S#. The vertical axis indicates load. The horizontal axis indicates time. Each of times t1 to t5 indicates a collection timing for each log collection period. In the graph 900, the system load Lc varies over time, and the load at an intermediate portion including times t3 and t4 is high.

It is assumed herein that logs for multiple software programs (OS, AP1, AP2, and AP3) running on the system S# are collected as logs for multiple items concerning the performance of the system S#. Vertical bars 901, 902 and 907 indicate a total collection load La which is a record value of a load requested to collect all the logs.

At times t1, t2, and t5, the system load Lc is low, and the system load Lc does not exceed the threshold Th even if all the logs are collected. Therefore, the task server 201 collects all the logs for the OS, the AP1, the AP2, and the AP3 at times t1, t2, and t5.

On the other hand, at times t3 and t4, the system load Lc is high, and the system load Lc exceeds the threshold Th if all the logs are collected. For this reason, the task server 201 determines the priorities (priority order) of the multiple software programs (OS, AP1, AP2, and AP3) based on the access counts of the collected logs (the reference counts of the performance information), and collects the logs by the next collection timing in a distributed manner that keeps the system load Lc from exceeding the threshold Th. The priority order of the software programs is assumed to be “OS→AP2→AP1→AP3” herein.

For example, the task server 201 collects some logs (for OS and AP2), which keep the system load Lc from exceeding the threshold Th, among the logs for the multiple software programs (OS, AP1, AP2, and AP3) at time t3, and collects the remaining logs (for AP1 and AP3) at time t3-2 between time t3 and time t4 that is the next collection timing. Time t3-2 is a middle time point (collection point) in the period from the current collection timing to the next collection timing. A vertical bar 903 represents the record value of the load requested to collect some logs (for OS and AP2). A vertical bar 904 represents the record value of the load requested to collect the remaining logs (for AP1 and AP3).

Thus, a situation where the load of the system S# exceeds the threshold Th and causes a slowdown is avoided at time t3 and the remaining logs are collected in the middle until the next collection timing. This makes it possible to collect a larger number of logs.

Similarly, the task server 201 collects some logs (for OS and AP2), which keep the system load Lc from exceeding the threshold Th, among the logs for the multiple software programs (OS, AP1, AP2, and AP3) at time t4, and collects the remaining logs (for AP1 and AP3) at time t4-2 between time t4 and time t5 that is the next collection timing. Time t4-2 is a middle time point (collection point) in the period from the current collection timing to the next collection timing. A vertical bar 905 represents the record value of the load requested to collect some logs (for OS and AP2). A vertical bar 906 represents the record value of the load requested to collect the remaining logs (for AP1 and AP3).

Thus, a situation where the load of the system S# exceeds the threshold Th and causes a slowdown is avoided at time t4 and the remaining logs are collected in the middle until the next collection timing. This makes it possible to collect a larger number of logs.

### Various Process Procedures of Management Server 202

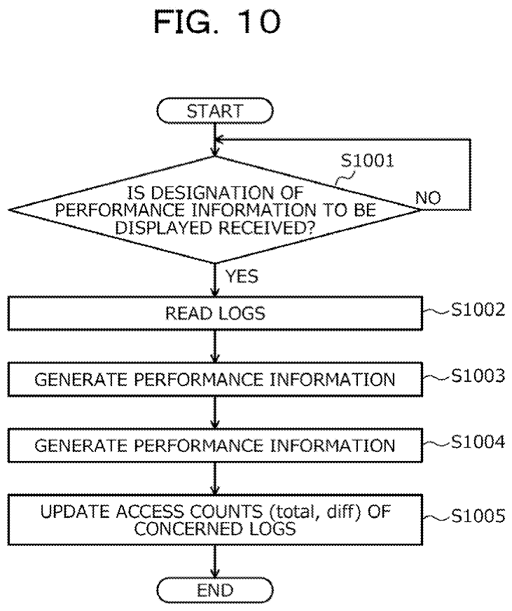

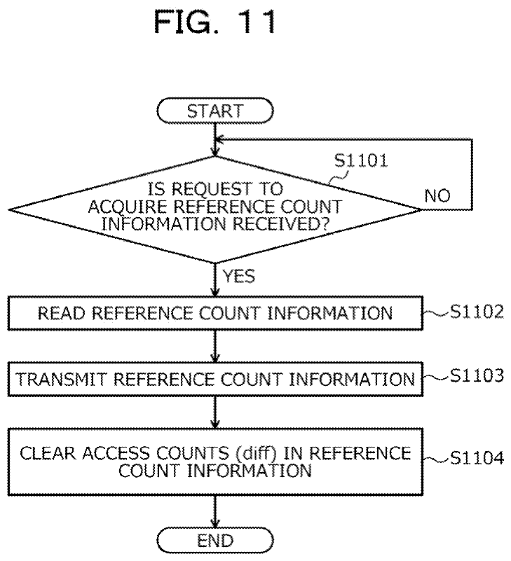

Next, various process procedures of the management server 202 will be described with reference to FIGS. 10 and 11. First, a reference count update process procedure of the management server 202 will be described with reference to FIG. 10.

FIG. 10 is a flowchart illustrating an example of the reference count update process procedure of the management server 202. In the flowchart of FIG. 10, first, the management server 202 determines whether or not a designation of performance information to be displayed is received from the operator terminal 203 (step S1001). The management server 202 waits to receive the designation of the performance information (No in step S1001).

When the management server 202 receives the designation of the performance information (Yes in step S1001), the management server 202 reads logs for displaying the designated performance information from the performance log DB 250 (step S1002). The management server 202 generates the designated performance information based on the read logs (step S1003).

Next, the management server 202 displays the generated performance information on the operator terminal 203 (step S1004). The management server 202 updates the access counts (total and diff) of the logs thus used in the reference count table (copy source) 260 (step S1005) and terminates the series of processing according to this flowchart.

Thus, in response to the reference to the performance information made by the operator for the performance monitoring of the system S#, it is possible to update (increment) the access counts of the logs used for displaying the referred performance information.

Next, a reference count response process procedure of the management server 202 will be described with reference to FIG. 11.

FIG. 11 is a flowchart illustrating an example of a reference count response process procedure of the management server 202. In the flowchart of FIG. 11, first, the management server 202 determines whether or not a request to acquire reference count information is received from the task server 201 (step S1101). The management server 202 waits to receive the request to acquire the reference count information (No in step S1101).

When the management server 202 receives the request to acquire the reference count information (Yes in step S1101), the management server 202 reads all the reference count information from the reference count table (copy source) 260 (step S1102). Next, the management server 202 transmits the read reference count information to the task server 201 (step S1103).

The management server 202 clears the access counts (diff) of the reference count information in the reference count table (copy source) 260 (step S1104), and terminates the series of processing according to this flowchart.

Thus, in response to a request from the task server 201, it is possible to provide the reference count information indicating the access counts of the logs accessed for performance monitoring among the collected logs for the multiple items concerning the performance of the system S#.

### Information Collection Process Procedure of Task Server 201

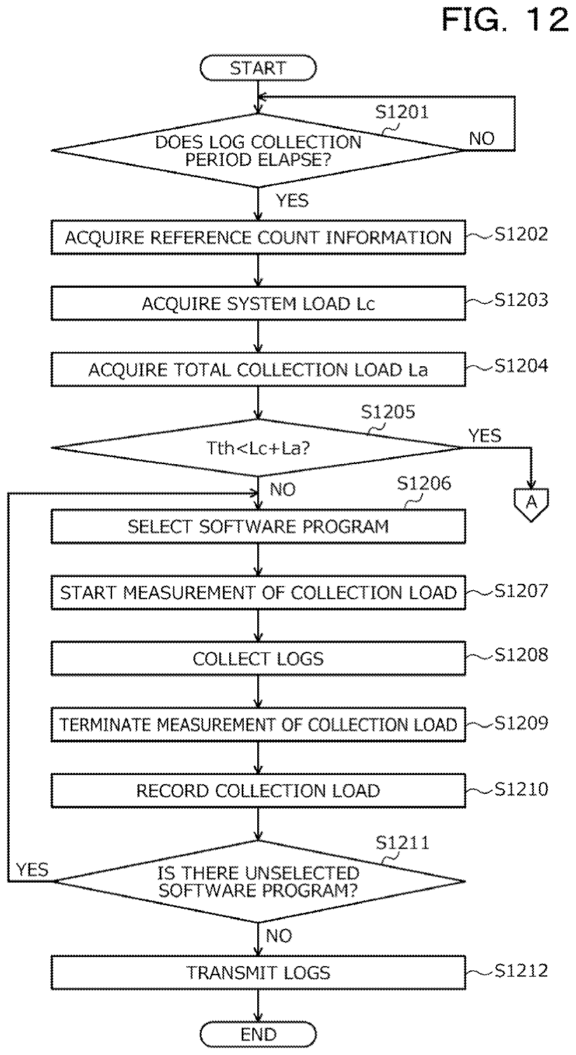

Next, an information collection process procedure of the task server 201 will be described with reference to FIGS. 12 to 16. It is assumed that logs concerning software programs running on the system S# (logs indicating the usage states of the respective resources by each software program) are collected as logs concerning the performance of the system S#.

FIGS. 12 to 16 are flowcharts illustrating an example of the information collection process procedure of the task server 201. In the flowchart illustrated in FIG. 12, the task server 201 determines whether the log collection period elapses from the start of performance monitoring of the system S# or from the previous collection timing (step S1201).

The task server 201 waits for the log collection period to elapse (No in step S1201). When the log collection period elapses (Yes in step S1201), the task server 201 transmits a request to acquire the reference count information to the management server 202 and thereby acquires the reference count information from the management server 202 (step S1202). The acquired reference count information is stored in the reference count table 230.

Next, the task server 201 acquires the system load Lc from the OS of the system S# (step S1203). Subsequently, the task server 201 acquires the total collection load La (Total/ap-total) by referring to the collection load table 220 (step S1204).

The task server 201 determines whether the total of the acquired system load Lc and the acquired total collection load La exceeds the threshold Th (step S1205). When the total is equal to or smaller than the threshold Th (No in step S1205), the task server 201 selects an unselected software program that is yet to be selected among the software programs running on the system S# (step S1206).

Next, the task server 201 starts a measurement of the load requested to collect the logs for the selected software program (step S1207). The task server 201 collects the logs for the selected software program (step S1208). Next, the task server 201 terminates the measurement of the load requested to collect the logs for the selected software program (step S1209).

The task server 201 records the measured collection load in the collection load table 220 (step S1210). Next, the task server 201 determines whether there is an unselected software program that is yet to be selected among the software programs running on the system S# (step S1211).

When there is an unselected software program (Yes in step S1211), the task server 201 returns to step S1206. On the other hand, when there is no unselected software program (No in step S1211), the task server 201 transmits the collected logs to the management server 202 (step S1212), and terminates the series of processing according to this flowchart.

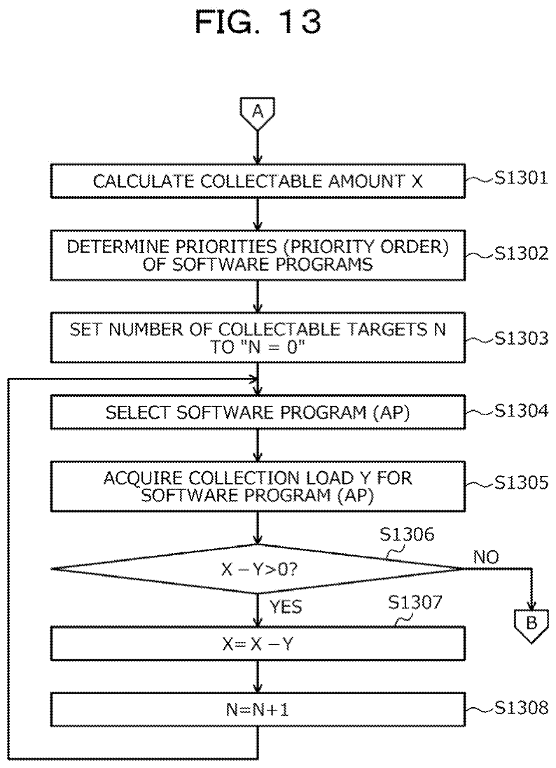

When the total exceeds the threshold Th in step S1205 (Yes in step S1205), the task server 201 proceeds to step S1301 illustrated in FIG. 13.

In the flowchart of FIG. 13, first, the task server 201 refers to the collection load table 220 and calculates a collectable amount X by subtracting the system load Lc and the load requested to collect the logs for the OS from the threshold Th (step S1301). The collectable amount X represents a load usable for log collection.

The task server 201 refers to the reference count table 230 to determine the priority (priority order) of each of the software programs (step S1302). The determined priority (priority order) of each software program is stored in the collection status table 240. Next, the task server 201 sets the number of collectable targets N to N=0 (step S1303). The number of collectable targets N represents the number of collection targets for which the logs are collectable.

The task server 201 refers to the collection status table 240 and selects an unselected software program in descending order of priority (step S1304). In this selection, the OS is excluded. Next, the task server 201 refers to the collection load table 220 and acquires a collection load Y (the record value of the load: ap-total) that was requested to collect the logs for the selected software program (AP) (step S1305).

The task server 201 determines whether a value obtained by subtracting the collection load Y from the collectable amount X is larger than 0 (step S1306). When the above value is larger than 0 (Yes in step S1306), the task server 201 sets the collectable amount X to “X=X−Y” (step S1307). Next, the task server 201 sets the number of collectable targets N to “N=N+1” (step S1308), and returns to step S1304.

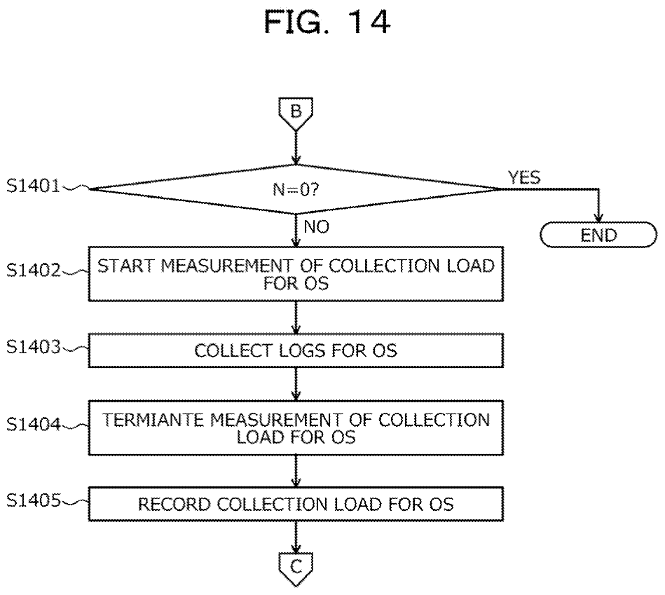

When the value is equal to or less than 0 in step S1306 (No in step S1306), the task server 201 proceeds to step S1401 illustrated in FIG. 14.

In the flowchart of FIG. 14, first, the task server 201 determines whether or not N is “N=0” (step S1401). When N is “N=0” (Yes in step S1401), the task server 201 terminates the series of processing according to this flowchart. In this case, logs are not collected at the current collection timing.

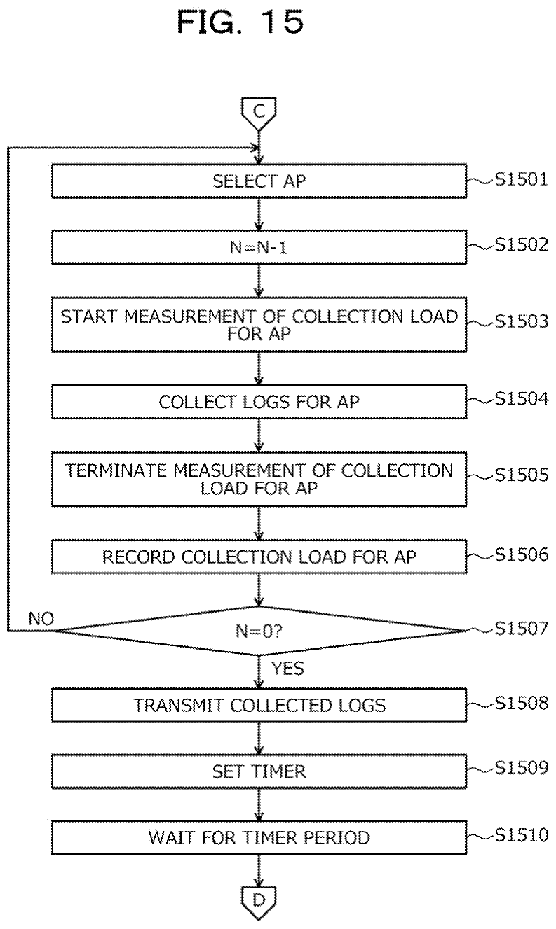

On the other hand, when N is not “N=0” (No in step S1401), the task server 201 starts a measurement of the load requested to collect the logs for the OS (step S1402). The task server 201 collects the logs for the OS (step S1403). Next, the task server 201 terminates the measurement of the load requested to collect the logs for the OS (step S1404). The task server 201 records the measured collection load for the OS in the collection load table 220 (step S1405), and proceeds to step S1501 illustrated in FIG. 15.

In the flowchart of FIG. 15, first, with reference to the collection status table 240, the task server 201 selects an AP having the highest priority among APs each having the collection flag of “0” (step S1501). Next, the task server 201 sets the number of collectable targets N to “N=N−1” (step S1502).

The task server 201 starts a measurement of the load requested to collect the logs for the selected AP (step S1503). The task server 201 collects the logs for the selected AP (step S1504). When the collection of the logs is completed, the collection flag of the selected AP in the collection status table 240 is changed to “1”.

Next, the task server 201 terminates the measurement of the load requested to collect the logs for the selected AP (step S1505). The task server 201 records the measured collection load for the AP in the collection load table 220 (step S1506). Next, the task server 201 determines whether or not N is “N=0” (step S1507).

When N is not “N=0” (No in step S1507), the task server 201 returns to step S1501. On the other hand, When N is “N=0” (Yes in step 51507), the task server 201 transmits the collected logs to the management server 202 (step S1508).

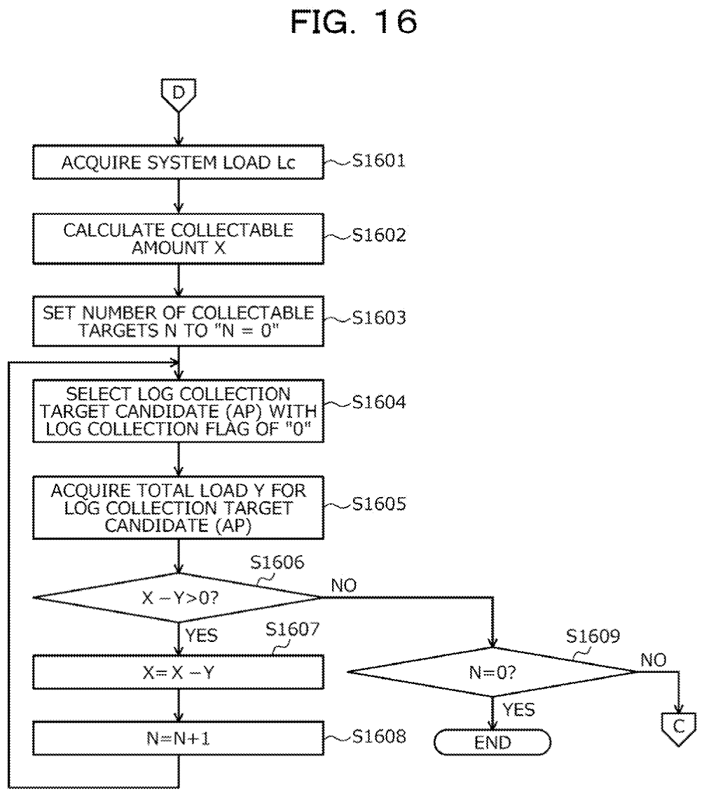

Next, the task server 201 sets a timer to expire at a predetermined time point (step S1509). The predetermined time point is set to, for example, a time point by which the period from the current collection timing to the next collection timing is divided into two. The task server 201 waits for the set timer period (step S1510), and proceeds to step S1601 illustrated in FIG. 16.

When the predetermined time point does not exist until the next collection timing in step S1509, the task server 201 terminates the series of processing according to this flowchart.

In the flowchart of FIG. 16, first, the task server 201 acquires the system load Lc from the OS of the system S# (step S1601). The task server 201 calculates the collectable amount X by subtracting the system load Lc from the threshold Th (step S1602).

Next, the task server 201 sets the number of collectable targets N to N=0 (step S1603). The task server 201 refers to the collection status table 240 and selects an AP having the highest priority among the APs each having the collection flag of “0” (step S1604). Next, the task server 201 refers to the collection load table 220 to acquire the collection load Y (the record value of the load: ap-total) that was requested to collect the logs for the selected AP (step S1605).

The task server 201 determines whether a value obtained by subtracting the collection load Y from the collectable amount X is larger than 0 (step S1606). When the above value is larger than 0 (Yes in step S1606), the task server 201 sets the collectable amount X to “X=X−Y” (step S1607). Next, the task server 201 sets the number of collectable targets N to “N=N+1” (step S1608), and returns to step S1604.

When the value is equal to or less than 0 in step S1606 (No in step S1606), the task server 201 determines whether or not N is “N=0” (step S1609). When N is not “N=0” (No in step S1609), the task server 201 returns to step S1501 illustrated in FIG. 15.

On the other hand, when N is “N=0” (Yes in step S1609), the task server 201 terminates the series of processing according to this flowchart. In this case, the task server 201 does not collect logs at the predetermined time point.

Thus, even when the load of the system S# varies during operation, it is possible to collect a larger number of logs while reducing the occurrence of a slowdown due to the collection of the logs.

### Second Example of Log Collection by Task Server 201

Next, a second example of log collection by the task server 201 will be described with reference to FIG. 17. The first example of log collection illustrated in FIG. 9 has been described for the case where the remaining logs (logs for the remaining items), which are not collected at the collection timing for each log collection period, are collected in the middle until the next collection timing. In the second example of log collection, a plurality of collection points are set until the next collection timing, so that the timings for collecting the remaining logs are increased and the number of logs collected at each collection point is reduced.

FIG. 17 is an explanatory diagram illustrating the second example of the log collection by the task server 201. In FIG. 17, a graph 1700 indicates a temporal change in the system load Lc of the system S#. The vertical axis indicates load. The horizontal axis indicates time. Each of times t1 to t5 indicates a collection timing for each log collection period. In the graph 1700, the system load Lc varies over time, and the load at an intermediate portion including times t3 and t4 is high.

It is assumed herein that logs for multiple software programs (OS, AP1, AP2, AP3, AP4, and AP5) running on the system S# are collected as the logs for the multiple items concerning the performance of the system S#. Vertical bars 1701, 1702 and 1708 indicate a total collection load La which is a record value of a load requested to collect all the logs.

At times t1, t2, and t5, the system load Lc is low, and the system load Lc does not exceed the threshold Th even if all the logs are collected. Therefore, the task server 201 collects all the logs for the OS, the AP1, the AP2, the AP3, the AP4, and the AP5 at times t1, t2, and t5.

On the other hand, at times t3 and t4, the system load Lc is high, and the system load Lc exceeds the threshold Th if all the logs are collected. For this reason, the task server 201 determines the priorities (priority order) of the multiple software programs (OS, AP1, AP2, AP3, AP4, and AP5) based on the access counts of the collected logs (the reference counts of the performance information), and collects the logs until the next collection timing in a distributed manner that keeps the system load Lc from exceeding the threshold Th. The priority order of the software programs is assumed to be OS→AP1→AP2→AP3→AP4→AP5.

For example, at time t3, some logs (for OS and AP1), which keep the system load Lc from exceeding the threshold Th, among the logs for the multiple software programs (OS, AP1, AP2, AP3, AP4, and AP5) are collected. In this case, the logs for the two collection targets in descending order of priority among the six collection targets are collected at time t3.

The task server 201 determines that it is possible to collect the logs for two collection targets at each collection point. For this reason, in order to collect the logs for the remaining four collection targets, the task server 201 divides the period from the current collection timing (time t3) to the next collection timing (time t4) into three, and sets the two dividing points (time t3-2 and t3-3) as collection points.

At time t3-2 that is the first collection point, the task server 201 collects the logs for two collection targets (AP2 and AP3) in descending order of priority among the remaining four collection targets. The task server 201 collects the logs for the remaining two collection targets (AP4 and AP5) at time t3-3 that is the second collection point. A vertical bar 1703 represents a record value of a load requested to collect the logs for the OS and the AP1. A vertical bar 1704 represents a record value of a load requested to collect the logs for the AP2 and the AP3. A vertical bar 1705 represents a record value of a load requested to collect the logs for the AP4 and the AP5.

Thus, a situation where the load of the system S# exceeds the threshold Th and causes a slowdown is avoided at time t3 and the remaining logs are collected in the distributed manner until the next collection timing. This makes it possible to collect a larger number of logs while collecting a smaller number of logs at each collection point.

At time t4, some logs (for OS, AP1, and AP2), which keep the system load Lc from exceeding the threshold Th, among the logs for the multiple software programs (OS, AP1, AP2, AP3, AP4, and AP5) are collected. In this case, the logs for the three collection targets in descending order of priority among the six collection targets are collected at time t4.

The task server 201 determines that it is possible to collect the logs for the three collection targets at each collection point. For this reason, in order to collect the logs for the remaining three collection targets, the task server 201 divides the period from the current collection timing (time t4) to the next collection timing (time t5) into two, and sets the one dividing point (time t4-2) as a collection point.

At time t4-2, the task server 201 collects the logs for the remaining three collection targets (AP3, AP4, and AP5). A vertical bar 1706 represents a record value of a load requested to collect the logs for the OS, the AP1, and the AP2. A vertical bar 1707 represents a record value of a load requested to collect the logs for the AP3, the AP4, and the AP5.

Thus, a situation where the load of the system S# exceeds the threshold Th and causes a slowdown is avoided at time t4 and the remaining logs are collected in the middle until the next collection timing. This makes it possible to collect a larger number of logs.

### Example of Determination of Resource-by-Resource Priority Order

Next, with reference to FIG. 18, description will be given of a case where a priority order on a resource-by-resource basis for software programs is determined based on the access counts of the logs indicating the usage states of the respective resources by each of the software programs. In this case, an item concerning the performance of the system S# is equivalent to the usage state of each resource by each software program running on the system S#.

FIG. 18 is an explanatory diagram illustrating an example of determination of a resource-by-resource priority order. FIG. 18 illustrates a collection load table 220. The task server 201 (determination unit 802) determines the resource-by-resource priority order for the software programs (OS, AP1, AP2, and AP3) based on the access counts of the logs indicating the usage states of the respective resources (CPU, memory, disk, and network) by each of the software programs.

For example, the task server 201 determines the priority order in descending order of the access counts of the logs indicating the usage states of the respective resources by the software programs. Here, diff is used as the access count. The logs indicating the usage states of the respective resources (CPU, memory, disk, and network) by the OS are to be preferentially collected.

In this case, the resource-by-resource priority order is “OS→AP2/CPU→AP2/network→AP2/memory→AP1/network→AP1/CPU→AP3/net work→ . . . ”. For example, AP2/CPU denotes the item indicating the usage state of the CPU by the AP2. AP1/network represents the item indicating the usage state of the network by the AP1. In FIG. 18, numbers in parentheses indicate the priority order.

This makes it possible to collect logs (logs indicating the usage states of the resources) for each of the resources used by the software programs running on the system S#. For example, when the threshold Th is “Th=80 [%]” and the system load Lc is “Lc=78.5 [%]”, the margin is 1.5 [%].

In this case, if the software-by-software priority order were determined, the AP for which the logs are collectable together with the logs for the OS would not be found. Here, the record values of the loads requested to collect the logs for the software programs (OS, AP1, AP2, and AP3) are the values in the collection load table 220 illustrated in FIG. 4. On the other hand, if the priority order is determined on the resource-by-resource basis, the logs for AP2/CPU (0.2 [%]) and AP2/network (0.2 [%]) are collectable together with the logs for the OS (1.0 [%]).

As described above, the task server 201 (information processing apparatus 101) according to the embodiment may acquire the system load Lc and the total collection load La when collecting the logs for the multiple items concerning the performance of the system. When the total of the system load Lc and the total collection load La exceeds the threshold Th, the task server 201 may determine a log collection target item from the multiple items based on the access counts of the logs accessed for performance monitoring among the logs collected for the multiple items, and collect the logs for the determined log collection target item.

Thus, even when the load of the monitoring target system (for example, the system S#) varies during operation, it is possible to collect logs important to the operator while reducing the occurrence of a slowdown due to the collection of the logs.

The task server 201 may determine a log collection target item in descending order of the access count of the logs among the multiple items.

Thus, it is possible to collect logs to be used for performance information in descending order of the reference count of the references which the operator has made for performance monitoring.

The task server 201 may collect the logs for the remaining items other than the log collection target items among the multiple items at a predetermined time point in the period from the current collection timing to the next collection timing.

Thus, the uncollected logs that are not collected at the current collection timing may be collected until the next collection timing.

The task server 201 may acquire the system load Lc at the predetermined time point in the period from the current collection timing to the next collection timing, determine a log collection target item from the remaining items, depending on the difference between the acquired system load Lc and the threshold Th, based on the access counts of the logs accessed for performance monitoring among the logs collected for the remaining items, and collect the logs for the determined log collection target item.

Thus, also when collecting the uncollected logs, it is possible to collect the logs important to the operator while reducing the occurrence of a slowdown.

The task server 201 may determine a predetermined time point (collection point) based on the number of log collection target items and the number of the remaining items determined at the current collection timing.

Thus, the number of divisions indicating the timings for collecting the logs for the remaining items may be changed in accordance with the number of the log collection target items for which the logs are collectable at one time. Thus, it is possible to appropriately distribute the load requested to collect the logs for the multiple items and to collect the logs for all the multiple items within a range of the load not exceeding the threshold Th, for example, without causing a slowdown.

When the total of the system load Lc and the total collection load La is equal to or smaller than the threshold Th, the task server 201 may collect all the logs for the multiple items.

Thus, all the logs concerning the performance of the system may be collected when it is expected that the system will not cause a slowdown even if the logs for all the multiple items are collected.

The task server 201 may determine a log collection target item(s) from the multiple items indicating the usage states of the resources by the multiple software programs running on the system.

Thus, the logs indicating the usage states of the resources (CPU, memory, disk, and network) by the software programs (OS and APs) running on the system may be collected as the logs concerning the performance of the system.

The task server 201 may use, as the access count of the logs, the access count (diff) of the logs accessed for performance monitoring from the previous collection timing to the current collection timing.

Thus, logs desired by the operator may be determined based on the latest frequency at which the operator has referred to the performance information.

The task server 201 may use, as the access count of the logs, the access count (total) of the logs accessed for performance monitoring in a period from the start of the performance monitoring to the current collection timing.

Thus, logs desired by the operator may be determined based on the frequency at which the operator has referred to the performance information after the start of the performance monitoring of the system.

The task server 201 may acquire, as the total collection load La, the total of the record values of the loads requested to lastly collect the logs for the multiple items.

Thus, it is possible to accurately estimate the load requested to collect the logs for the multiple items.

Therefore, in collecting logs for performance monitoring, the task server 201 (information processing apparatus 101) according to the embodiment is able to, even when the system load varies during operation, level the system load to avoid the occurrence of a service slowdown, and reduce the occurrence of a situation where the desired performance information is not referable by the operator, thereby causing no hindrance to performance trouble investigation.

The information collection method described in the embodiment may be implemented by executing a program prepared in advance on a computer such as a personal computer or a workstation. The information collection program described according to the present embodiment is recorded on a computer-readable recording medium such as a hard disk, a flexible disk, a CD-ROM, a DVD, or a USB memory and is executed as a result of being read from the recording medium by a computer. The information collection program may also be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information collection program causing a computer to execute a process comprising:
when collecting logs for a plurality of items concerning performance of a system, acquiring a current value of a load of the system and a record value of a load requested to collect the logs for the plurality of items;
when a total of the current value and the record value exceeds a threshold, determining a log collection target item from the plurality of items based on access counts of logs accessed for performance monitoring among the logs collected for the plurality of items; and
collecting a log for the determined log collection target item.

2. The non-transitory computer-readable recording medium according to claim 1, wherein
in the determining, the log collection target item is determined from the plurality of items in descending order of the access count of the log.

3. The non-transitory computer-readable recording medium according to claim 1, wherein
the logs for the plurality of items are collected at a predetermined time interval, and
the program causes the computer to execute the process comprising collecting logs for the remaining items other than the log collection target item among the plurality of items at a predetermined time point in a period from a current collection timing to a next collection timing.

4. The non-transitory computer-readable recording medium according to claim 3, wherein
the program causes the computer to execute the process comprising acquiring the current value of the load of the system at the predetermined time point,
determining a log collection target item from the remaining items, depending on a difference between the acquired current value and the threshold, based on the access counts of the logs accessed for performance monitoring among the logs collected for the remaining items, and
collecting a log for the determined log collection target item.

5. The non-transitory computer-readable recording medium according to claim 3, wherein the program causes the computer to execute the process comprising determining the predetermined time point based on the number of the log collection target items and the number of the remaining items determined at the current collection timing.

6. The non-transitory computer-readable recording medium according to claim 1, wherein the program causes the computer to execute the process comprising collecting all the logs for the plurality of items when the total of the current value and the record values is equal to or less than the threshold.

7. The non-transitory computer-readable recording medium according to claim 1, wherein each of the plurality of items indicates a usage state of a resource by each of a plurality of software programs running on the system.

8. The non-transitory computer-readable recording medium according to claim 1, wherein
the logs for the plurality of items are collected at a predetermined time interval, and
the access counts are access counts of the logs accessed for performance monitoring in a period from a previous collection timing to a current collection timing.

9. The non-transitory computer-readable recording medium according to claim 1, wherein
the logs for the plurality of items are collected at a predetermined time interval, and
the access counts are access counts of the logs accessed for performance monitoring in a period from start of performance monitoring to a current collection timing.

10. The non-transitory computer-readable recording medium according to claim 1, wherein
the record value is obtained by adding up the record values of the loads which were requested to lastly collect the logs respectively for the plurality of items.

11. An information collection method comprising:
when collecting logs for a plurality of items concerning performance of a system, acquiring, by a computer, a current value of a load of the system and a record value of a load requested to collect the logs for the plurality of items;
when a total of the current value and the record value exceeds a threshold, determining a log collection target item from the plurality of items based on access counts of logs accessed for performance monitoring among the logs collected for the plurality of items; and
collecting a log for the determined log collection target item.

12. An information processing apparatus comprising:
a memory; and
a processor coupled to the memory and configured to:
when collecting logs for a plurality of items concerning performance of a system, acquire a current value of a load of the system and a record value of a load requested to collect the logs for the plurality of items;
when a total of the current value and the record value exceeds a threshold, determine a log collection target item from the plurality of items based on access counts of logs accessed for performance monitoring among the logs collected for the plurality of items; and
collect a log for the determined log collection target item.
